(19) United States
(12) Patent Application Publication
(10) Pub. No.: US 2012/0300079 A1
(43) Pub. Date: Nov. 29, 2012

(54) Object-oriented cable camera system

(76) Inventor: Richard Thomas Hale, Brooklyn, NY (US)

(21) Appl. No.: 13/385,823

(22) Filed: Mar. 8, 2012

Related U.S. Application Data
(60) Provisional application No. 61/464,752, filed on Mar. 9, 2011.

(51) Int. Cl. H04N 7/18

(52) U.S. Cl. 348/157; 348/E07.085

(57) ABSTRACT

An object-oriented cable camera system that processes the sports ball's position and automatically follows the ball in play in lock step to the sports ball in the sporting arena. The invention is comprised of a cable camera, a computer control system controlling the position of the cable camera and the camera's settings, a tracking chip attached to the sports ball, and a sports ball. A tracking chip is attached to the sports ball. The computer control system monitors the position of the sports ball through this tracking chip and automatically adjusts the cable camera's relative position to the sports ball keeping the cable camera in lock step with the sports ball and therefore providing a superior viewing experience. When the sports ball moves, the computer control system recognizes this change of position and automatically moves the cable camera's position to mirror the sports ball's new position.

### CROSS REFERENCE TO RELATED APPLICATIONS

This application is based on provisional application Ser. No. 61/464,752, filed on Mar. 9, 2011.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of video cameras and more specifically to cable cameras used in the sporting arena.

The cable camera is a computer-controlled, stabilized, cable-suspended camera system. The system is maneuvered through three dimensions in the open space over a playing area of a stadium or arena by computer-controlled cable-drive system. It is responsible for bringing video game-like camera angles to television sports coverage. The original technology was invented by Garrett Brown in 1984. The cable camera has been in limited use since the mid 1980s when the technology was first patented but until the mid 1990s progress was slow due to limitations in computer and servo motor technology. NBC debuted the first wire-flown remote-controlled camera used in sports coverage in February 2001 for the XFL. ESPN first used cable cameras in 2001 for an NFL pre-season telecast and then consistently in 2002 for Sunday Night Football broadcasts. Since then, ESPN and sister-network ABC have made widespread use of cable cameras for NCAA football, Monday Night Football and Super Bowl.XXXVII respectively.

Cable cameras were invented by Garrett Brown (U.S. Pat. No. 4,710,819) indicating a camera that is suspended by cables and moved in three dimensions space, controlled by a computer controlled drive and gyro-stabilized. This is the main patent behind the field of cable cameras and as of this date has expired and cannot be renewed therefore opening the field to competitors. Since then the major advancements in cable cameras have been increases in speed, stability and lightness of the cable camera system. No major new features have emerged in this field.

There is also a patent related to camera technology in the sports field that is worth mentioning in relationship to this novel device. The patent titled “camera based tracking and position determination for sporting events” by Gerald Curry (Publication number: US 2010/0026809 A1, filed Jul. 29, 2009) does highlight the advantages of tracking sports balls in sporting events automatically by video cameras. In the patent, however, the invention only tracks the sports ball using a camera's pan, tilt and zoom function and does not refer to tracking the sports ball with changes to the camera's physical position nor does it refer to tracking the sports ball's position through the use of cable cameras which allows for greater camera speeds, nimbleness and proximity to the action. Adding these novel features of automatically tracking the sports ball's position with the camera's actual position as well as using the cable camera's overall greater speed and nimbleness makes the advantages of this embodiment far greater and non obvious over the invention outlined in the patent titled “camera based tracking and position determination for sporting events.”

The main shortcomings and inadequacies of the prior technology is relying on a human operator for control of the cable camera's position. This human controlled feature means that the cable camera cannot keep up with the ball in play, cannot accurately track the ball, cannot allow for multiple cable cameras on the field at the same time (and therefore cannot allow for multiple simultaneous viewing angles from cable cameras) and cannot be used in sports that are non stop in nature (such as soccer and basketball). It also ultimately leaves the viewer lagging behind on the action and with an inferior viewing experience.

### BRIEF SUMMARY OF THE INVENTION

The primary object of the invention is to allow for greater immersion in sports games by the viewer by having the cable camera automatically track the ball in play.

Another object of the invention is to allow for multiple cable cameras on the field at the same time to provide different simultaneous viewing angles from cable cameras. Currently, only one cable camera is able to be on the sports field at a time because multiple cable cameras could get tangled or interfere with each other.

Another object of the invention is to allow for cable cameras on the field in non-stop sports like soccer, basketball, and hockey. Previously, cable cameras could not handle non-stop action sports.

A further object of the invention is to allow for quicker and smoother reactions by the cable cameras than what is possible via human controlled cable cameras.

Yet another object of the invention is to allow for automatic camera movements to better frame the shot, allow for greater fluidity and stabililty to the shot, and allow for better tracking of the sports ball.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an object-oriented cable camera system comprising: a cable camera, a computer control system controlling the position of the cable camera and the camera's settings, a tracking chip attached to the sports ball, and a sports ball.

In accordance with a preferred embodiment of the invention, there is disclosed a process for an object-oriented cable camera system comprising the steps of: a cable camera being positioned by a computer control system at a certain distance away from the sports ball, a computer control system monitoring the position of the sports ball through its tracking chip, when the sports ball moves, the computer control system picks up on the sports ball's change in location and adjusts the cable camera's position to continue to be in lock step with the sports ball.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side view of the present invention indicating how the computer will keep the cable camera in lockstep with the sports ball. The computer control system controls the location of the cable camera. It aligns the cable camera with the sports ball's position based on the data from the Tracking Chip on the cable camera and the sports ball. In this case, the cable camera is positioned 15 feet above and 15 feet behind the sports ball in lock step with the sports ball. Note: the tracking chip on the cable camera can be used or the computer control system can know the location of the cable camera through other means such as its own custom tracking system. A tracking chip on the cable camera is therefore not crucial for the functioning of this invention and should not be a limiting feature to the scope of this invention.

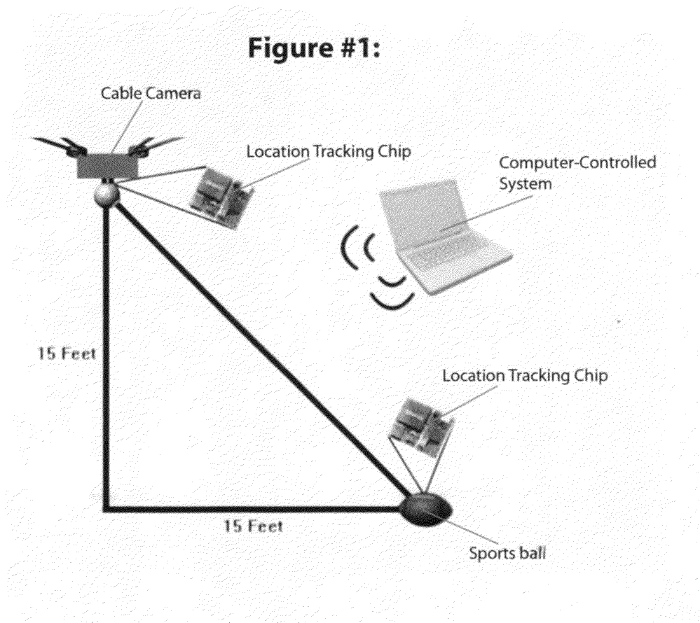

FIG. 2 is a perspective view of the present invention tracking the ball in play through movement of the camera. In addition to the cable camera's movement, the camera controlled by the computer rotates and zooms to make sure the ball is always in the center of the frame. This rotation and zooming also can make up for the sports ball's high speed and for any lag in the cable camera's position.

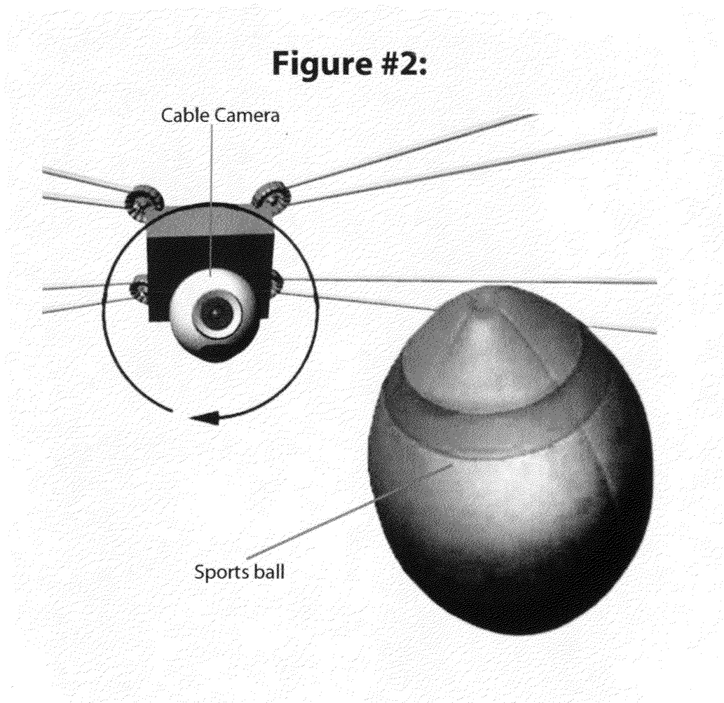

FIG. 3 is a series of perspective views of the present invention in action tracking a sports ball coupled with the camera's corresponding views at that moment. It shows how the cable camera could react to a pass and what its views would be like. The camera's position and settings are for illustrative purposes and this invention does not necessarily need to be limited to this camera's position and angle in practice.

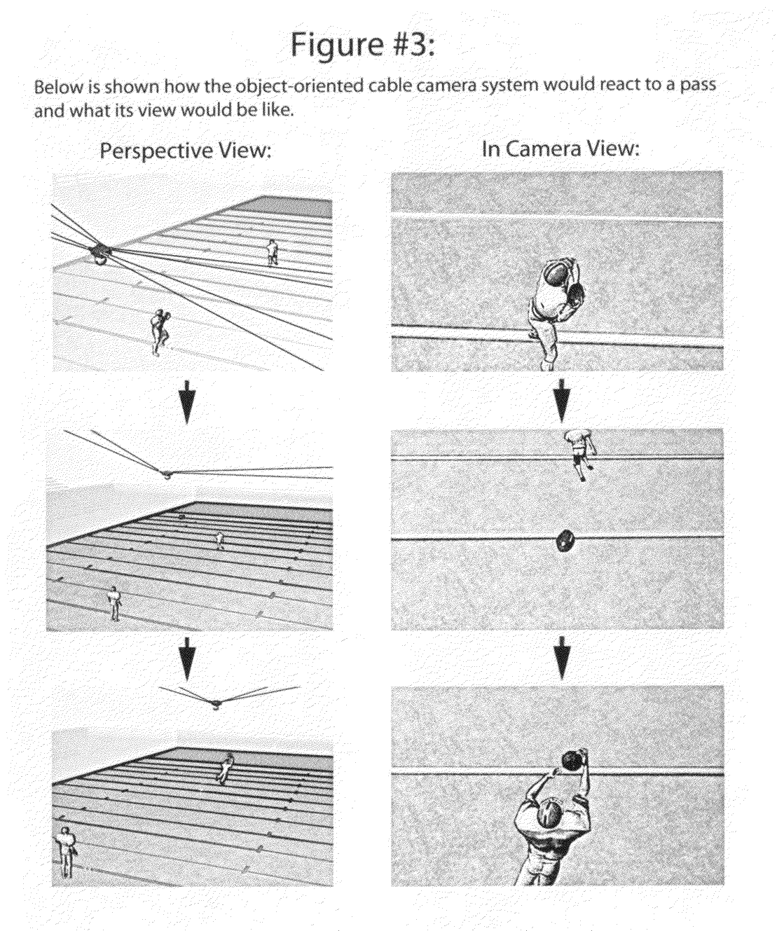

FIG. 4 is a perspective view of the programmable barriers for the cable camera. The computer control system can program in barriers based on the positional data thereby limiting the cable camera's range of motion. This feature is especially important for indoor sporting arenas or other confined areas.

FIG. 5 is a perspective view of multiple cable cameras in use on the field and their corresponding views. The ability to allow for multiple cable cameras on the field at the same time allows for editing simultaneously between different views.

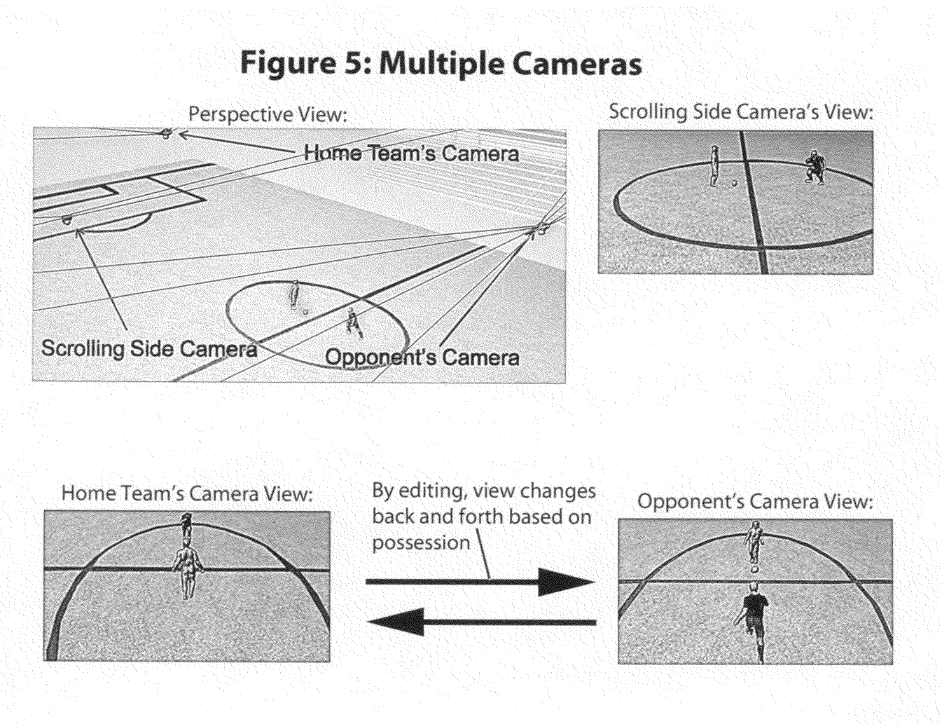

FIG. 6 is a flow chart showing the cable camera's computer-controlled system's automated decision making when the ball is moved and when it comes to a stop.

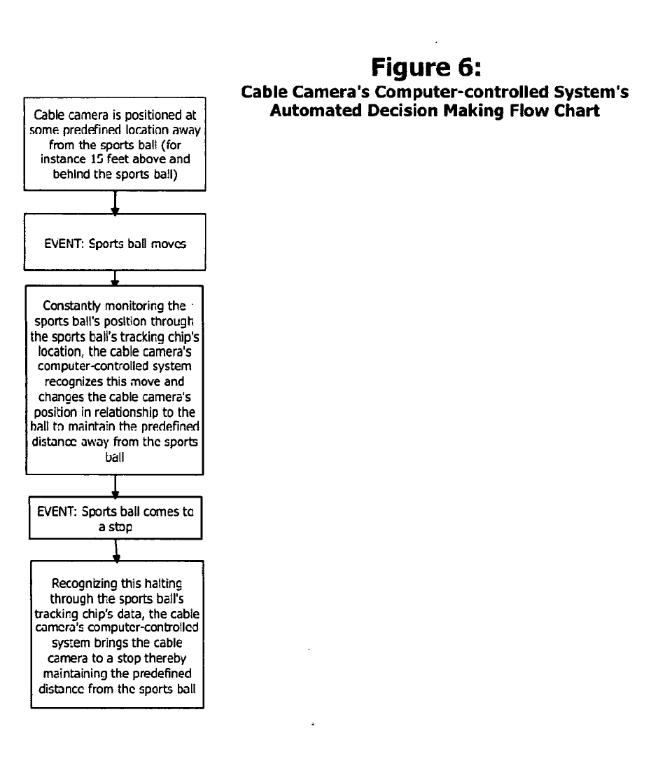

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The general purpose of the present invention is to provide a new cable camera system that has many of the advantages of the cable cameras mentioned heretofore and many novel features that result in a new cable camera system which is not anticipated, rendered obvious, suggested, or even implied by any of the prior art for the cable cameras, either alone or in any combination thereof.

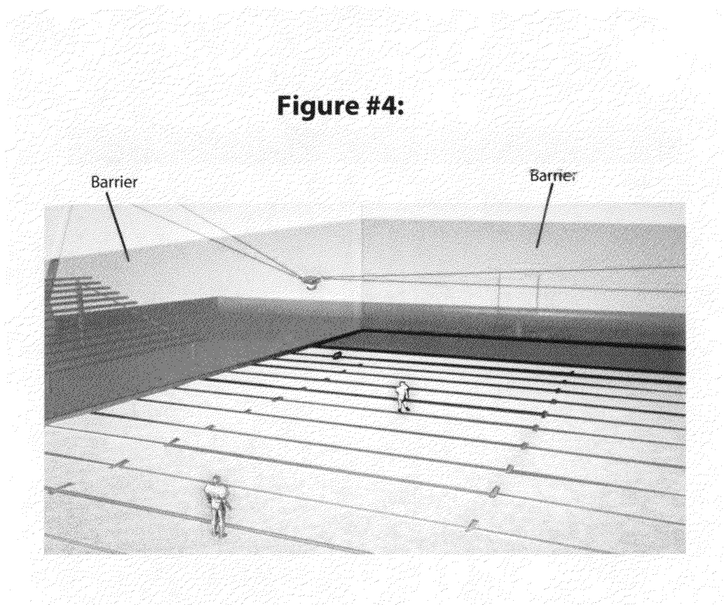

To attain this, the present invention generally comprises a cable camera system, a sports ball, a computer control system and a tracking chip. The cable camera system comprising of cables to support the camera, a film, video or digital camera, a stabilizing system, and motors to control the camera's position as well as support points to hold up the cables attached to the cable camera. The sports ball can include a soccer ball, a hockey puck, a football, a rugby ball, a basketball, a golf ball, etc. It basically includes anything used in a sport that would be a center of interest for the viewer. The computer control system allows for a human operator to control the camera system with a degree of precision. It includes a computer that processes the position of the camera and other data such as camera information (camera aperture setting, zoom level, pan, tilt, focus settings, etc.). It also allows for the computer to take over positioning the cable camera so as to lock on to the ball in play based on its positional data ascertained through the tracking chip's data. To clarify, “to lock on” or “locking on” for this invention means to keep the cable camera at a set distance away from the sports ball and always maintain this distance except for situations where the human operator overrides the computer's automatic control or where the sports ball falls outside of programmable barriers (shown in FIG. 4). The tracking chip is a small device that attaches to the ball in play and relays its position back to a computer control system. This tracking device could include GPS, magnetic, infrared, RFID (Radio-frequency identification), reflector, sonar or other type of tracking technology. It could also include image recognition software used to track the sports ball's location.

There has thus been outlined, rather broadly, the more important features of the invention in order that the detailed description thereof may be better understood, and in order that the present contribution to the art may be better appreciated. There are additional features of the invention that will be described hereinafter.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What I claim as my invention is:

1. An object-oriented cable camera system that processes the sports ball's position and automatically follows the ball in play in the sporting arena in lock step to the ball's position comprising of:
a cable camera;
a computer control system controlling the position of the cable camera and the camera's settings;
a tracking chip attached to the sports ball;
a sports ball.

2. A process for an object-oriented cable camera system that processes the sports ball's position and automatically follows the ball in play in the sporting arena comprising the steps of:
a cable camera being positioned by the computer control system at some predefined position in relation to the sports ball
when the ball is moved, the cable camera machine recognizes this change by its monitoring of the sports ball's position through the sports ball's tracking chip
the cable camera then automatically moves in response to the sports ball's move to keep its position in lock step with the sports ball
when the sports ball comes to a stop, the cable camera recognizes this change again through the sports ball's tracking chip's location and comes automatically to a stop maintaining the cable camera's predefined position in relation to the sports ball
